(19) United States
(12) Patent Application Publication
(10) Pub. No.: US 2024/0202592 A1
(43) Pub. Date: Jun. 20, 2024

(54) METHOD OF SUPPORTING DYNAMIC SPLITTING EXECUTION OF MACHINE LEARNING MODEL IN COMMUNICATION SYSTEM

(71) Applicant: ELECTRONICS AND TELECOMMUNICATIONS RESEARCH INSTITUTE, Daejeon (KR)

(72) Inventor: Tae Chul Hong, Daejeon (KR)

(21) Appl. No.: 18/527,498

(22) Filed: Dec. 4, 2023

(30) Foreign Application Priority Data
Dec. 14, 2022 (KR) 10-2022-0174562

(51) Int. Cl. G06N 20/00

(52) U.S. Cl. CPC G06N 20/00

(57) ABSTRACT

A method of supporting dynamic splitting execution of a machine learning model in a communication system is provided. The method includes transmitting device information to the service server by using the edge device, determining a splitting execution type of the machine learning model and transmitting splitting execution information including the determined splitting execution type to the edge device by using the service server, based on the device information, and performing an arithmetic operation on the machine learning model by using at least one of the edge device and the service server, based on the determined splitting execution type.

### CROSS-REFERENCE TO RELATED APPLICATION

This application claims the benefit of the Korean Patent Application No. 10-2022-0174562 filed on Dec. 14, 2022, which is hereby incorporated by reference as if fully set forth herein.

### BACKGROUND

### 1. Field of the Invention

The present invention relates to technology of a communication system for distributed-processing an arithmetic operation on a machine learning model for executing an artificial intelligence (AI) service by using an edge device, a mobile edge server, and a cloud server.

### 2. Description of Related Art

Because AI services such as deep learning need a number of arithmetic resources, AI services are mainly used in a cloud environment, but a method of using AI services in an edge device is being researched recently.

To use AI services in edge devices, methods should be complexly considered where low-power and high-performance dedicated hardware and conventional AI models are lightweight and optimal, and insufficient arithmetic resources are used in mobile edge computing or cloud computing.

AI hardware accelerators denote technology applied to dedicated hardware for implementing and executing AI. In AI hardware accelerators, performance is still insufficient to use AI services, used in clouds, in edge devices. It is difficult to implement lightweight AI models without a reduction in performance. Therefore, to use various AI services in edge devices, it is needed to support mobile edge computing or cloud computing by using a communication system.

### SUMMARY

An aspect of the present invention is directed to providing a method which may dynamically split a machine learning model and may efficiently support dynamic splitting execution by using a communication system for executing split machine learning models in mobile edge computing and cloud computing, so as to complement the insufficient arithmetic performance of an edge device.

To achieve these and other advantages and in accordance with the purpose of the invention, as embodied and broadly described herein, there is provided a method of supporting dynamic splitting execution of a machine learning model in a communication system, the method including: transmitting device information to a service server by using an edge device; determining a splitting execution type of the machine learning model and transmitting splitting execution information including the determined splitting execution type to the edge device by using the service server, based on the device information; and performing an arithmetic operation on the machine learning model by using at least one of the edge device and the service server, based on the determined splitting execution type.

A method of supporting dynamic splitting execution of a machine learning model in a communication system according to another embodiment of the present invention includes: changing a splitting execution type of the machine learning model previously determined based on a resource status change of an edge device by using the edge device; transmitting splitting execution change information including the changed splitting execution type to a service server by using the edge device; and changing an operation scheme of the machine learning model by using at least one of the edge device and the service server, based on the changed splitting execution type.

A method of supporting dynamic splitting execution of a machine learning model in a communication system according to another embodiment of the present invention includes: transmitting splitting execution information including a splitting execution type of the machine learning model to a service server and a network management server by using an edge device; performing an arithmetic operation on the machine learning model by using at least one of the edge device and the service server, based on the splitting execution type; monitoring a current communication session generated between the edge device and the service server to determine a current communication quality class of the current communication session by using the network management server; configuring a final communication session by using the network management server, based on a result of comparison of the current communication quality class and a reference communication quality class; and performing data communication for performing an arithmetic operation on the machine learning model by using the edge device and the service server, based on the configured final communication session.

A method of supporting dynamic splitting execution of a machine learning model in a communication system according to another embodiment of the present invention includes: configuring a communication session for performing data communication by using an edge device and a service server; changing a splitting execution type of the machine learning model by using one of the edge device and the service server, based on a resource status thereof; sharing the changed splitting execution type over a communication network by using the edge device and the service server; performing data communication based on the changed splitting execution type to perform an arithmetic operation on the machine learning model by using the edge device and the service server; monitoring data traffic based on the data communication to determine whether to change the splitting execution type, by using a network management server; and in a case where the network management server determines whether to change the splitting execution type, updating the communication session to a communication quality class for smoothly supporting the changed splitting execution type by using a data transfer device, based on a result of the determination of the network management server.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram illustrating a configuration of a communication system environment according to an embodiment of the present invention.

FIG. 2 is a diagram for describing a splitting execution process of a machine learning model by using mobile communication according to an embodiment of the present invention.

FIG. 3 is a graph illustrating data traffic changed based on a splitting execution type of a machine learning model according to an embodiment of the present invention.

FIG. 4 is a flowchart for describing a process of determining and performing dynamic splitting execution of a machine learning model according to an embodiment of the present invention.

FIG. 5 is a flowchart for describing a process of changing a splitting execution type by using an edge device on the basis of a situation change (resource status change) in a process of performing dynamic splitting execution of a machine learning model according to an embodiment of the present invention.

FIG. 6 is a flowchart for describing a process of changing a splitting execution type by using a service server on the basis of a situation change in a process of performing dynamic splitting execution of a machine learning model according to an embodiment of the present invention.

FIG. 7 is a flowchart for describing a process of supporting dynamic splitting execution by using a network management server according to an embodiment of the present invention.

FIG. 8 is a flowchart for describing a process of supporting dynamic splitting execution by using a network management server managing a mobile communication network without receiving splitting execution information from an edge device or a service server, based on dynamic splitting execution of a machine learning model according to an embodiment of the present invention.

FIG. 9 is a block diagram of a computing device for implementing a method illustrated in FIGS. 4 to 8.

### DETAILED DESCRIPTION OF THE INVENTION

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

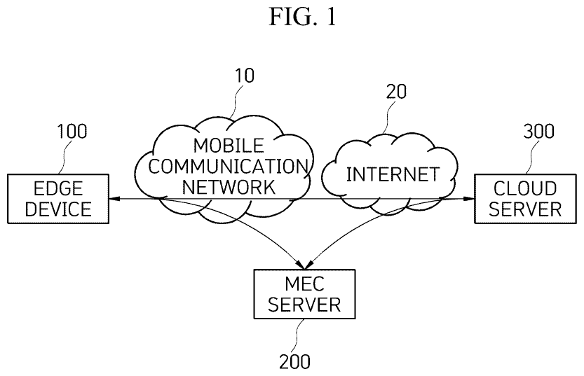

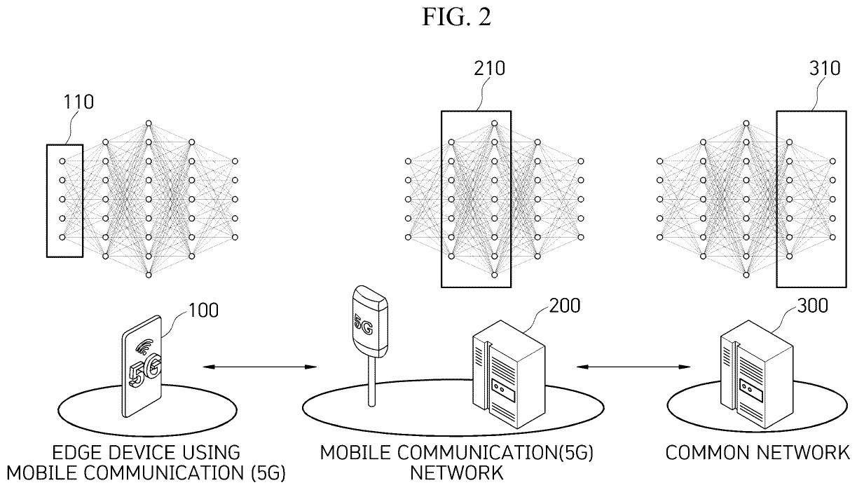

FIG. 1 is a diagram illustrating a configuration of a communication system environment according to an embodiment of the present invention. FIG. 2 is a diagram for describing a splitting execution process of a machine learning model by using mobile communication according to an embodiment of the present invention.

Referring to FIG. 1, an edge device 100 supporting a mobile communication function may autonomously use an AI service, based on resources thereof. Also, the edge device 100 may use an AI service with the aid of a mobile edge computing (MEC) server 200 or a cloud server 300.

To use the aid of the cloud server 300 or the MEC server 200, the edge device 100 may access a mobile communication network 10 such as a 5G communication network, and then, may access the MEC server 200 accessing the mobile communication network 100 and/or the cloud server 300 accessing an Internet network 20, thereby using an AI service.

In deep learning, the number of arithmetic operations and the number of parameters for calculation may be far more, and thus, a number of resources may be needed. To process a number of arithmetic operations in the edge device 100, low-power and high-efficiency dedicated hardware accelerators are being developed, but it may be difficult to execute all AI services, provided by the cloud server 300, in the edge device 100.

Therefore, in an embodiment of the present invention, as illustrated in FIG. 2, a number of layers included in deep learning may be split, an arithmetic operation on a split layer 110 may be performed by the edge device 100, an arithmetic operation on the other split layer 210 may be performed by the MEC server 200, and an arithmetic operation on the other split layer 310 may be performed by the cloud server 300.

Subsequently, an operation result of the MEC server 200 may be transmitted to the cloud server 300, and the cloud server 300 may transmit a final operation result, obtained by combining the operation result of the MEC server 200 and an operation result of the cloud server 300, to the edge device 100, whereby the edge device 100 may use an AI service.

When the edge device 100 starts the AI service, a splitting execution type illustrated in FIG. 2 may be determined based on a resource and a status of the edge device 100.

A main element which determines a splitting execution type may be the edge device 100, the MEC server 200, or the cloud server 300. In this case, the MEC server 200 or the cloud server 300 may determine whether to perform dynamic splitting execution, based on resources and/or status information transferred from the edge device 100.

In a process of executing an AI service as a splitting execution type which is determined in a start step of the AI service, a problem may occur in executing of the AI service, based on a status change of the edge device 100, the MEC server 200, or the cloud server 300. Therefore, when the occurrence of a problem is sensed, it may be needed to determine an optimal splitting execution type suitable for a situation by changing a previously determined splitting execution type to another splitting execution type.

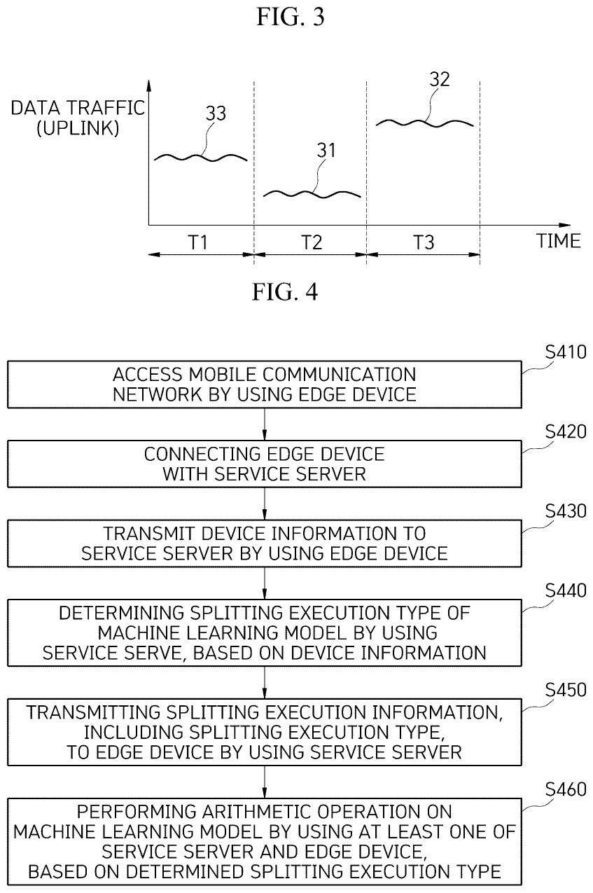

FIG. 3 is a graph illustrating data traffic changed based on a splitting execution type of a machine learning model according to an embodiment of the present invention.

Referring to FIG. 3, when a splitting execution type is changed, data traffic (uplink) which is to be supported in the mobile communication network 10 may be changed based on the changed splitting execution type.

For example, when it is assumed that all of the edge device 100, the MEC server 200, and the cloud server 300 perform an arithmetic operation needed for execution of an AI service in a time interval T1, the edge device 100 performs an arithmetic operation needed for execution of the AI service in a time interval T2, and the MEC server 200 and the cloud server 300 perform an arithmetic operation needed for execution of the AI service in a time interval T3, data traffic which is to be supported by the mobile communication network may be lowest in the time interval T2 and may be highest in the time interval T3, and data traffic of the time interval T1 may be a medium between data traffic of the time interval T2 and data traffic of the time interval T3.

When a splitting execution type of a machine learning model is changed, it may be needed to re-set a communication path of the edge device 100. When the mobile communication network 10 is a 5G network, routing information about a user plane function (UPF) may be updated so that a data transfer device transfers data traffic to a changed destination on the basis of the changed splitting execution type. That is, the data transfer device may route a communication path of the data traffic to the MEC server 200 accessed to the mobile communication network 10, or may route the data traffic to the cloud server 300 accessed to the Internet network 20. Here, the data transfer device may be, for example, a gateway, a router, or a device configured by a combination thereof.

The splitting execution type may be constant, and split sections of layers included in the machine learning model may be changed. In this case, a data traffic communication path may be constant, but the amount of data traffic may be changed.

Changing of a split section may denote adjustment of the number of layers allocated to the edge device 100, the MEC server 200, and the cloud server 300.

For example, based on an initially determined splitting execution type, when the edge device 100 is set to perform an arithmetic operation on one layer 110 as illustrated in FIG. 2, the number of layers which are allocated to the edge device 100 to perform an arithmetic operation on two layers according to changing of a split section may increase.

Alternatively, based on an initially determined splitting execution type, when the MEC server 210 is set to perform an arithmetic operation on two layers 210 as illustrated in FIG. 2, the number of layers which are allocated to the edge device 100 to perform an arithmetic operation on one layer or an arithmetic operation on three or more layers according to changing of a split section may be adjusted.

In FIG. 3, the general forms of different data traffic based on a splitting execution type are shown, and the amount of real data traffic may be changed based on layers split in performing real splitting execution.

The mobile communication network 10 should support a change in a communication path and data traffic so as to smoothly support an initially determined splitting execution type or a changed splitting execution type.

FIG. 4 is a flowchart for describing a process of determining and performing dynamic splitting execution of a machine learning model according to an embodiment of the present invention.

Referring to FIG. 4, first, at step S410, the edge device 100 may access the mobile communication network 10.

Subsequently, at step S420, the edge device 100 may be connected with the service server 200 or 300 by the mobile communication network 10.

Subsequently, at step S430, the edge device 100 may transmit information (hereinafter referred to as device information), needed for performing of an AI service, to the service server 200 or 300. Here, the device information may include, for example, information associated with an operation capability and a battery status of the edge device 100. The information associated with the operation capability of the edge device 100 may be, for example, information associated with performance of a central processing unit (CPU), a graphics processing unit (GPU), and a memory each included in the edge device 100.

Subsequently, at step S440, the service server 200 or 300 may determine a splitting execution type of a machine learning model, based on the device information.

Subsequently, at step S450, the service server 200 or 300 may transmit splitting execution information, including the determined splitting execution type, to the edge device 100.

Subsequently, at step S460, at least one of the edge device 100 and the service server 200 or 300 may perform an arithmetic operation on the machine learning model, based on the determined splitting execution type, and may perform data communication for performing an arithmetic operation.

In an embodiment, the splitting execution information generated at step S450 may include information representing one of a type where the edge device performs all arithmetic operations on the machine learning model, a type where the service server performs all arithmetic operations on the machine learning model, and a type where the edge device and the service server split and perform all arithmetic operations on the machine learning model.

In an embodiment, it is described that the service server 200 or 300 determines a splitting execution type of the machine learning model at step S440, but the edge device 100 may determine the splitting execution type.

In an embodiment, in a case where the edge device 100 determines the splitting execution type, the edge device 100 may transmit splitting execution information, including the determined splitting execution type, to the service server 200 and/or 300.

In an embodiment, the splitting execution information may include layer information for identifying layers (an input layer, a middle layer (or a hidden layer), or an output layer) allocated to each of the edge device 100 and the service server 200 or 300 among a plurality of layers included in the machine learning model. Here, the layer information may further include information about the number of layers allocated to each of the edge device 100 and the service server 200 or 300.

In an embodiment, step S460 of performing an arithmetic operation on the machine learning model on the basis of the determined splitting execution type may be a step of performing an arithmetic operation on all layers included in the machine learning model on the basis of the determined splitting execution type.

In an embodiment, step S460 of performing an arithmetic operation on the machine learning model on the basis of the determined splitting execution type may be a step of performing an arithmetic operation on all layers included in the machine learning model by using the service server 200 or 300, based on the determined splitting execution type.

In an embodiment, step S460 of performing an arithmetic operation on the machine learning model on the basis of the determined splitting execution type may be a step of performing an arithmetic operation on some of all layers included in the machine learning model by using the edge device 100 and performing an arithmetic operation on the other layers by using the service server 200 or 300.

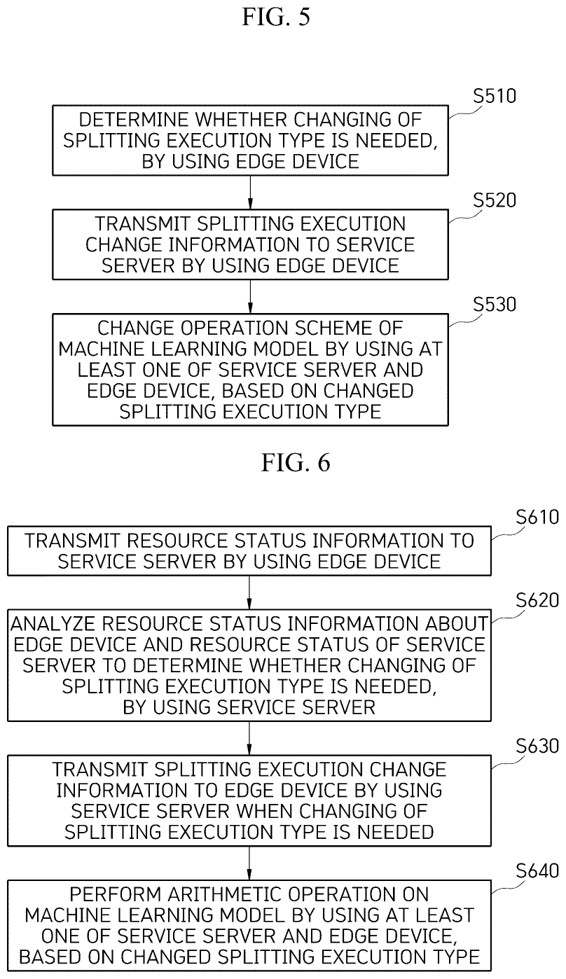

FIG. 5 is a flowchart for describing a process of changing a splitting execution type by using an edge device on the basis of a situation change (resource status change) in a process of performing dynamic splitting execution of a machine learning model according to an embodiment of the present invention.

Referring to FIG. 5, first, at step S510, the edge device 100 may determine whether changing of a previously determined splitting execution type of the machine learning model is needed based on a resource status change including a current communication status change and a battery status change.

Subsequently, at step S520, when it is determined that changing of the splitting execution type is needed, the edge device 100 may change the splitting execution type, generate splitting execution change information including the changed splitting execution type, and transmit the splitting execution change information to the service server 200 or 300. In this case, the splitting execution change information may be transmitted as a type which requests changing of the splitting execution type.

Subsequently, at step S530, when the edge device 100 receives a response message corresponding to the request message from the service server 200 or 300, at least one of the edge device 100 and the service server 200 or 300 may perform an arithmetic operation on the machine learning model, based on the changed splitting execution type. That is, at least one of the edge device 100 and the service server 200 or 300 may change an operation scheme of the machine learning model, based on the changed splitting execution type.

In an embodiment, the response message may be a message which denotes the allowance of changing of the splitting execution type by the edge device 100.

In an embodiment, at step S520, when changing of the splitting execution type is not determined due to a busy situation, the server 200 or 300 may maintain a current splitting execution type. That is, the service server 200 or 300 may determine the number of available resources of the service server 200 or 300 to determine whether it is possible to process arithmetic operations changed based on the changed splitting execution type and may determine the allowance of a change request from the edge device 100, based on a result of the determination.

In an embodiment, step S530 of changing an operation scheme of the machine learning model may be a step of changing a scheme, which performs an arithmetic operation on all layers included in the machine learning model by using the edge device 100, to a scheme which performs an arithmetic operation on all layers included in the machine learning model by using the service server 200 or 300.

In an embodiment, step S530 of changing the operation scheme of the machine learning model may be a step of changing a scheme, which performs an arithmetic operation on all layers included in the machine learning model by using the service server 200 or 300, to a scheme which performs an arithmetic operation on all layers included in the machine learning model by using the edge device 100.

In an embodiment, step S530 of changing the operation scheme of the machine learning model may be a step of changing the number of layers allocated to the edge device 100 and the number of layers allocated to the service server 200 or 300 among all layers included in the machine learning model.

Furthermore, steps of FIG. 4 and steps of FIG. 5 may be integrated. In this case, steps of FIG. 5 may be performed after step S460 of FIG. 4.

FIG. 6 is a flowchart for describing a process of changing a splitting execution type by using a service server on the basis of a situation change in a process of performing dynamic splitting execution of a machine learning model according to an embodiment of the present invention.

Referring to FIG. 6, at step S610, the edge device 100 may transmit resource status information including a battery status and a current communication status to the service server 200 or 300.

Subsequently, at step S620, the service server 200 or 300 may analyze resource status information about the edge device 100 and a resource status of the service server 200 or 300 to determine whether changing of a splitting execution type is needed.

Subsequently, at step S630, when it is determined that changing of the splitting execution type is needed, the service server 200 or 300 may change the splitting execution type and may transmit splitting execution change information including a changed splitting execution type to the edge device 100. At this time, the splitting execution change information may be transmitted in a message form.

Subsequently, at step S640, when the service server 200 or 300 receives a response message corresponding to the request message from the edge device 100, at least one of the edge device 100 and the service server 200 or 300 may perform an arithmetic operation on the machine learning model, based on the changed splitting execution type. That is, at least one of the edge device 100 and the service server 200 or 300 may perform an arithmetic operation on a changed layer section, based on the changed splitting execution type.

As illustrated in FIGS. 5 and 6, changing of the splitting execution type may be determined by the edge device 100 or the service server 200 or 300.

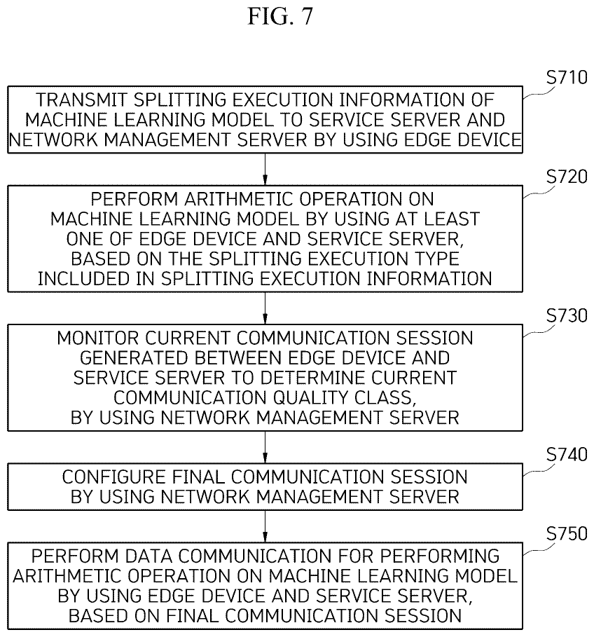

FIG. 7 is a flowchart for describing a process of supporting dynamic splitting execution by using a network management server according to an embodiment of the present invention.

Referring to FIG. 7, first, at step S710, the edge device 100 may transmit splitting execution information including a splitting execution type of the machine learning model to the service server 200 or 300 and the network management server (not shown in FIG. 1).

In an embodiment of the present invention, it may be assumed that the edge device 100 and the service server 200 or 300 share model information in a case which provides splitting execution information to the service server 200 or 300.

However, because the network management server does not know model information, in a case which provides the splitting execution information to the network management server, the splitting execution information may be provided in the form of information such as a transmission speed and a delay time needed for the determined splitting execution type, or may be provided as information which is known by the network management server as in Table 1.

Subsequently, at step S720, at least one of the edge device 100 and the service server 200 or 300 may perform an arithmetic operation on the machine learning model, based on the splitting execution type.

Subsequently, at step S730, the network management server may monitor a current communication session generated between the edge device 100 and the service server 200 or 300 to determine a current communication quality class of the current communication session.

Subsequently, at step S740, the network management server may configure a final communication session, based on a result of comparison of the current communication quality class and a reference communication quality class.

Subsequently, at step S750, the edge device and the service server may perform data communication for performing an arithmetic operation on the machine learning model, based on the configured final communication session.

In an embodiment, the splitting execution information may include a splitting execution type changed based on a resource status change of the edge device.

In an embodiment, step S730 may include a step of determining the reference communication quality class for smoothly supporting the splitting execution type.

In an embodiment, the step of determining the reference communication quality class may be a step of determining the amount of traffic and a delay time condition for smoothly supporting the splitting execution type by using the network management server.

In an embodiment, the reference communication quality class may be calculated based on a mapping table where a mapping relationship between the splitting execution type and a communication quality class is previously defined.

In an embodiment, the mapping table may be shown in the following Table 1.

TABLE 1

| | Desired |
|---|---|
| | communication |
| Splitting execution type | quality class |
| Performing all arithmetic operations on a machine | Lv1 |
| learning model in an edge device, desired | |
| transmission speed D1, and delay time T1 | |
| Performing all arithmetic operations on a machine | Lv3 |
| learning model in a service server (MEC server or | |
| cloud server), desired transmission speed D3, and | |
| delay time T3 | |
| Distributed-performing an arithmetic operation on | Lv2 |
| a machine learning model in an edge device and a | |
| service server (MEC server or cloud server), desired | |
| transmission speed D2, and delay time T2 | |

In an embodiment, in Table 1, Lv1 may denote a level representing lowest communication quality, Lv3 may denote a level representing highest communication quality, and Lv2 may denote a level representing medium communication quality between Lv1 and Lv3.

In an embodiment, step S740 of configuring the final communication session may include a step of configuring the final communication session as the current communication session when the current communication quality class is equal to the reference communication quality class and a step of configuring a new communication session as the final communication session when the current communication quality class differs from the reference communication quality class.

In an embodiment, when a communication quality class has a digitized value, step S740 of configuring the final communication session may include a step of configuring the final communication session as the current communication session when a difference value between the current communication quality class and the reference communication quality class is within an allowable error range and a step of configuring the new communication session as the final communication session when the difference value between the current communication quality class and the reference communication quality class is greater than a threshold value.

That is, when the current communication quality is equal to the reference communication quality or a difference value therebetween is within an allowable error range, the current communication session may be intactly maintained, and when the current communication quality differs from the reference communication quality, the new communication session may be generated.

In an embodiment, a process of generating the new communication session may be a process of updating routing information about a user plane function (UPF) so that a data transfer device (for example, a gateway, a router, or the like) cooperating with the network management server transfers the data traffic to a determined destination, based on the splitting execution type.

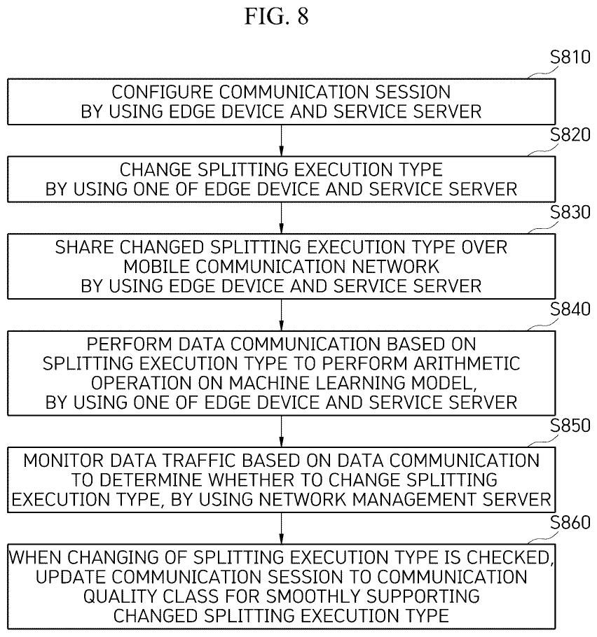

FIG. 8 is a flowchart for describing a process of supporting dynamic splitting execution by using a network management server managing a mobile communication network without receiving splitting execution information from an edge device or a service server, based on dynamic splitting execution of a machine learning model according to an embodiment of the present invention.

Referring to FIG. 8, at step S810, the edge device 100 and the service server 200 or 300 may configure a communication session for performing data communication.

Subsequently, at step S820, one of the edge device 100 and the service server 200 or 300 may determine whether changing of the splitting execution type of the machine learning model is needed, based on a resource status of each of the edge device 100 and the service server 200 or 300, and when it is determined that changing of the splitting execution type of the machine learning model is needed, one of the edge device 100 and the service server 200 or 300 may change the splitting execution type of the machine learning model.

Subsequently, at step S830, the edge device 100 and the service server 200 or 300 may share the changed splitting execution type over the mobile communication network.

Subsequently, at step S840, at least one of the edge device 100 and the service server 200 or 300 may perform data communication based on the splitting execution type to perform an arithmetic operation on the machine learning model.

Subsequently, at step S850, the network management server may monitor data traffic based on the data communication to determine whether to change the splitting execution type.

Subsequently, at step S860, in a case where the network management server determines whether changing of the splitting execution type is needed, the data transfer device (for example, a gateway or a router) may update the communication session to a communication quality class for smoothly supporting the changed splitting execution type, based on a result of the determination.

In an embodiment, step S850 of determining whether to change the splitting execution type may be a step of monitoring a level change of the data traffic and/or a destination change of the data traffic (a communication path change of the data traffic) to determine whether to change the splitting execution type.

The network management server managing the mobile communication network 10 may sense the level change of the data traffic and/or the destination change of the data traffic to determine whether to change the splitting execution type, in a state where information associated with changing of the splitting execution type is not received from the edge device 100 and the service server 200 or 300.

In an embodiment, step S850 of determining whether to change the splitting execution type may be a step of learn pattern data of the data traffic to determine whether to change the splitting execution type, by using an AI model which is modeled to predict changing of the splitting execution type.

In an embodiment, in a case where the AI model is not used, step S850 of determining whether to change the splitting execution type may include a step of calculating a movement average value of the data traffic during a certain period and a step of determining whether to change the splitting execution type, based on a result of comparison of the movement average value and a reference value.

In an embodiment, the reference value may be a value which is previously set for determining whether to change the splitting execution type.

In an embodiment, when the movement average value is greater than the reference value, the network management server may determine that the splitting execution type is changed.

In an embodiment, step S850 of determining whether to change the splitting execution type may be determined as in the following Equation 1.

$$\begin{matrix}\vert MV ( t ) - MV ( t - span ) \vert > {TH}_{MS} , & t \geq \end{matrix} span \qquad [ Equation 1 ]$$

Here, MV(t) may denote a movement average value of data traffic (data transmission rate) at a time t, THMs may denote a reference value for determining changing of the splitting execution type, and span may denote a period for determining changing of the data traffic.

In an embodiment, a case where a destination of the data traffic is changed while maintaining the same communication session may be a case where an execution element and split sections of layers included in the machine learning model are changed, and in this case, the edge device 100 may set the reference value, which is for sensing a level change of previous data traffic, to be low.

In an embodiment, step S860 of updating the communication session may be a step of updating routing information about a UPF so that the data transfer device (not shown) transfers the data traffic to a changed destination, based on the changed splitting execution type.

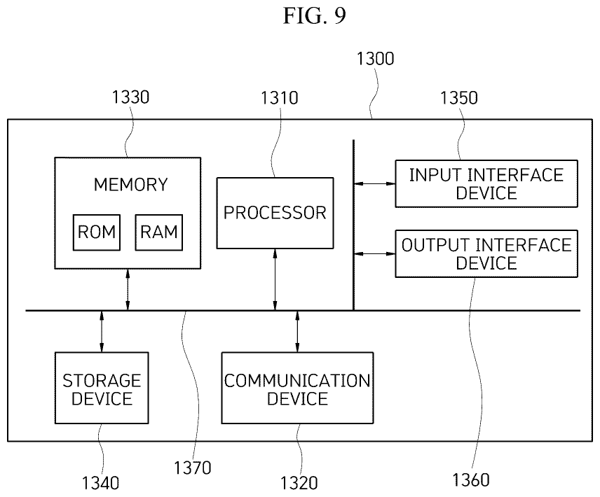

FIG. 9 is a block diagram of a computing device for implementing a method illustrated in FIGS. 4 to 8.

Referring to FIG. 9, a computing device 1300 according to an embodiment of the present disclosure may be included in each of the edge device 100, the MEC server 200, the cloud server 300, the network management server, and the data transfer device (for example, a gateway, a router, or the like), for implementing the method illustrated in FIGS. 4 to 8.

The computing device 1300 may include at least one of a processor 1310, a memory 1330, an input interface device 1350, an output interface device 1360, and a storage device 1340, which communicate with one another through a bus 1370. The computing device 1300 may include a communication device 1320 capable of accessing the mobile communication network and Internet. Although not shown, the computing device 1300 may further include a battery.

The communication device 1320 may be configured to include known communication elements for supporting wired/wireless Internet, 3G, LTE, 4G, 5G, WiFi, and Bluetooth.

The processor 1310 may be a central processing unit (CPU), a graphics processing unit (GPU), a microcontroller unit (MCU), a field programmable gate array (FPGA) chip, or a system on chip (SoC), or may be a semiconductor device which executes an instruction stored in the memory 1330 or the storage device 1340.

The processor included in the edge device 100, the MEC server 200, the cloud server 300, the network management server, and/or the data transfer device (for example, a gateway, a router, or the like) may execute a program for performing a relevant step among the steps illustrated in FIGS. 4 to 8 and may process data, a message, information, and a value output through an executed program.

The memory 1330 and the storage device 1340 each included in the edge device 100, the MEC server 200, the cloud server 300, the network management server, and/or the data transfer device (for example, a gateway, a router, or the like) may be various types of volatile or non-volatile storage mediums.

For example, the memory 1330 may include read only memory (ROM) and random access memory (RAM). In an embodiment of the present invention, the memory 1330 may be disposed in or outside the processor 1310 and may be connected with the processor 1310 through various means known to those skilled in the art.

Also, the machine learning model according to an embodiment of the present invention may be stored in the storage device 1340 included in the edge device 100, the MEC server 200, the cloud server 300, the network management server, and/or the data transfer device (for example, a gateway, a router, or the like) in common.

Various instructions and program codes for executing and controlling an AI model may be stored in the storage device 1340.

The machine learning model may be an artificial neural network configured to include a plurality of layers referred to as an input layer, a middle layer, and an output layer. The middle layer may be referred to as a hidden layer. Each of the input layer, the middle layer, and the output layer may be configured to include a plurality of layers. Each of the plurality of layers may include a plurality of nodes, and a node of each layer may be connected with a plurality of nodes included in an adjacent layer.

The processor 1310 included in the edge device 100, the MEC server 200, and the cloud server 300 may perform an arithmetic operation on layers included in the machine learning model. In this case, the processor 1310 included in the edge device 100, the MEC server 200, and the cloud server 300 may perform an arithmetic operation on all layers or some layers included in the machine learning model, based on a splitting execution type of the machine learning model.

The processor 1310 included in the edge device 100, the MEC server 200, and the cloud server 300 may determine a splitting execution type of the machine learning model, based on a resource status and a resource status change of a device including the processor 1310.

An embodiment of the present invention may be implemented as a method implemented in a computer, or may be implemented as a non-transitory computer-readable medium storing a computer-executable instruction. In an embodiment, when executed by the processor, the computer-readable instruction may perform a method according to at least one aspect of the present invention. Also, the method according to an embodiment of the present invention may be implemented as a program instruction type capable of being performed by various computer means and may be stored in a computer-readable recording medium.

The computer-readable recording medium may include a program instruction, a data file, or a data structure, or a combination thereof. The program instruction recorded in the computer-readable recording medium may be specially designed for an embodiment of the present invention, or may be known to those skilled in the computer software art and may be used. The computer-readable recording medium may store may include a hardware device which stores and executes the program instruction. For example, the computer-readable recording medium may be a magnetic media such as a hard disk, a floppy disk, and a magnetic tape, an optical media such as CD-ROM or DVD, a magneto-optical media such as a floptical disk, ROM, RAM, or flash memory. The program instruction may include a high-level language code executable by a computer such as an interpreter, in addition to a machine language code such as being generated by a compiler.

According to the embodiments of the present invention, a plurality of devices provided in a communication network (for example, a 5G network and Internet) may perform dynamic splitting execution (or distributed execution) of a machine learning model on the basis of a splitting execution type, and the communication network may provide communication quality (QoS) suitable for the splitting execution type, whereby an edge device may smoothly use an AI service.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of supporting dynamic splitting execution of a machine learning model in a communication system including an edge device and a service server connected with each other over a communication network, the method comprising:
transmitting device information to the service server by using the edge device;
determining a splitting execution type of the machine learning model and transmitting splitting execution information including the determined splitting execution type to the edge device by using the service server, based on the device information; and
performing an arithmetic operation on the machine learning model by using at least one of the edge device and the service server, based on the determined splitting execution type.

2. The method of claim 1, wherein the splitting execution information comprises information representing one of a type where the edge device performs all arithmetic operations on the machine learning model, a type where the service server performs all arithmetic operations on the machine learning model, and a type where the edge device and the service server split and perform all arithmetic operations on the machine learning model.

3. The method of claim 1, wherein the splitting execution information comprises layer information representing layers allocated to each of the edge device among a plurality of layers included in the machine learning model and layer information representing layers allocated to the service server among the plurality of layers.

4. The method of claim 1, wherein the performing of the arithmetic operation on the machine learning model comprises performing an arithmetic operation on all layers included in the machine learning model, based on the determined splitting execution type.

5. The method of claim 1, wherein the performing of the arithmetic operation on the machine learning model comprises performing an arithmetic operation on all layers included in the machine learning model by using the service server, based on the determined splitting execution type.

6. The method of claim 1, wherein the performing of the arithmetic operation on the machine learning model comprises performing an arithmetic operation on some of all layers included in the machine learning model by using the edge device and performing an arithmetic operation on the other layers by using the service server.

7. A method of supporting dynamic splitting execution of a machine learning model in a communication system including an edge device and a service server connected with each other over a communication network, the method comprising:
changing a splitting execution type of the machine learning model previously determined based on a resource status change of the edge device by using the edge device;
transmitting splitting execution change information including the changed splitting execution type to the service server by using the edge device; and
changing an operation scheme of the machine learning model by using at least one of the edge device and the service server, based on the changed splitting execution type.

8. The method of claim 7, wherein the changing of the operation scheme of the machine learning model comprises changing a scheme, which performs an arithmetic operation on all layers included in the machine learning model by using the edge device, to a scheme which performs an arithmetic operation on all layers included in the machine learning model by using the service server.

9. The method of claim 7, wherein the changing of the operation scheme of the machine learning model comprises changing a scheme, which performs an arithmetic operation on all layers included in the machine learning model by using the service server, to a scheme which performs an arithmetic operation on all layers included in the machine learning model by using the edge device.

10. The method of claim 7, wherein the changing of the operation scheme of the machine learning model comprises changing the number of layers allocated to the edge device and the number of layers allocated to the service server among all layers included in the machine learning model.

11. A method of supporting dynamic splitting execution of a machine learning model in a communication system including an edge device and a service server connected with each other over a communication network, the method comprising:
transmitting splitting execution information including a splitting execution type of the machine learning model to the service server and the network management server by using the edge device;
performing an arithmetic operation on the machine learning model by using at least one of the edge device and the service server, based on the splitting execution type;
monitoring a current communication session generated between the edge device and the service server to determine a current communication quality class of the current communication session by using the network management server;
configuring a final communication session by using the network management server, based on a result of comparison of the current communication quality class and a reference communication quality class; and
performing data communication for performing an arithmetic operation on the machine learning model by using the edge device and the service server, based on the configured final communication session.

12. The method of claim 11, wherein the splitting execution information comprises a splitting execution type changed based on a resource status change of the edge device.

13. The method of claim 11, further comprising determining a reference communication quality class for smoothly supporting the splitting execution type by using the network management server.

14. The method of claim 13, wherein the determining of the reference communication quality class comprises calculating the reference communication quality class, based on a mapping table where a mapping relationship between the splitting execution type and a communication quality class is previously defined.

15. The method of claim 11, wherein the configuring of the final communication session comprises:
when the current communication quality class is equal to the reference communication quality class, configuring the current communication session as the final communication session; and
when the current communication quality class differs from the reference communication quality class, configuring a new communication session as the final communication session.

16. A method of supporting dynamic splitting execution of a machine learning model in a communication system including an edge device and a service server connected with each other over a communication network, the method comprising:
configuring a communication session for performing data communication by using the edge device and the service server;
changing a splitting execution type of the machine learning model by using one of the edge device and the service server, based on a resource status thereof;
sharing the changed splitting execution type over the communication network by using the edge device and the service server;
performing data communication based on the changed splitting execution type to perform an arithmetic operation on the machine learning model by using the edge device and the service server;
monitoring data traffic based on the data communication to determine whether to change the splitting execution type, by using the network management server; and
in a case where the network management server determines whether to change the splitting execution type, updating the communication session to a communication quality class for smoothly supporting the changed splitting execution type by using a data transfer device, based on a result of the determination of the network management server.

17. The method of claim 16, wherein the determining whether to change the splitting execution type comprises monitoring a level change of the data traffic and a destination change of the data traffic to determine whether to change the splitting execution type.

18. The method of claim 16, wherein the determining whether to change the splitting execution type comprises:
calculating a movement average value of the data traffic during a certain period; and
determining whether to change the splitting execution type, based on a result of comparison of the movement average value and a reference value.

19. The method of claim 18, wherein the reference value is a value which is previously set for determining whether to change the splitting execution type.

20. The method of claim 16, wherein the updating of the communication session comprises updating routing information about a user plane function (UPF) so that the data transfer device transfers the data traffic to a changed destination, based on the changed splitting execution type.
